(19) United States
(12) Patent Application Publication
(10) Pub. No.: US 2008/0319771 A1
(43) Pub. Date: Dec. 25, 2008

(54) SELECTIVE DATA FEED DISTRIBUTION ARCHITECTURE

(75) Inventor: Jonathan Lawson Shriver-Blake, Seattle, WA (US)

Correspondence Address: AMIN, TUROCY & CALVIN, LLP, 127 Public Square, 57th Floor, Key Tower, CLEVELAND, OH, 44114, US

(73) Assignee: Microsoft Corporation, Redmond, WA (US)

(21) Appl. No.: 11/765,238

(22) Filed: Jun. 19, 2007

(51) Int. Cl. G06Q 10/00

(52) U.S. Cl. 705/1

(57) ABSTRACT

An architecture for providing data feeds to clients in a service-based platform environment is provided where the platform stores an immense amount of data regarding transactions occurring on the platform. In one aspect, the platform operates in a partner context such that partners are clients to the platform service, and the partner exposes the service to its own customers as well. In this regard, data feeds can be transmitted as local copies to the partner from the service to facilitate customized viewing and analyzing of the data beyond that offered by the service platform. To this end, the partner can created custom applications and services that provide access to the data for customers and the partner itself. This mitigates service-side processing of requests for data by partners and customers of the partners, as well as storage on the service platform.

### BACKGROUND

The evolution of computers and networking technologies from high-cost, low performance data processing systems to low cost, high-performance communication, problem solving, and entertainment systems has provided a cost-effective and time saving means to lessen the burden of performing every day tasks such as correspondence, bill paying, shopping, budgeting information and gathering, etc. For example, a computing system interfaced to the Internet, by way of wire or wireless technology, can provide a user with a channel for nearly instantaneous access to a wealth of information from a repository of web sites and servers located around the world. Such a system, as well, allows a user to not only gather information, but also to provide information to disparate sources. As such, online data storing and management has become increasingly popular. This has also led to increasing requests for such data and size of data warehouses.

For example, in service platforms where a service is provided to a plurality of clients, such as a cellular phone service platform or a web conferencing and collaboration platform, data can be logged and tracked regarding all transactional use of the system for a given client, for example. This data can accumulate quickly as the system scales. Additionally, this data can be of value to the service itself and users thereof. In one example, the service can utilize the service data to bill the client for services used, reporting, and/or business intelligence. Additionally, the data can be of value to the client to track usage; this can provide insight into, for example, how much usage is left before crossing a service-level threshold. This information is typically requested by querying the platform for the data from predefined user interfaces, programming interfaces, and/or services, such as web-services. Thus, the information available regarding the data is limited to the interfaces and services offered by the platform.

Moreover, service-based platforms can employ a scheme whereby the service is offered to one or more partners that offer the service, or a modified version thereof, to a plurality of their own clients. In this regard, requests for data can come from one or more of the clients on behalf of one or more of the platforms. Adding this level of abstraction can increase the number of requests exponentially. In addition to fielding the plurality of requests, the service platform can also be burdened with storing and maintaining the data warehouse that stores all of the transaction data. In some instances, the transaction data can scale exponentially with addition of new clients and partners creating an extreme burden for the platform to maintain the data.

### SUMMARY

The following presents a simplified summary in order to provide a basic understanding of some aspects described herein. This summary is not an extensive overview nor is intended to identify key/critical elements or to delineate the scope of the various aspects described herein. Its sole purpose is to present some concepts in a simplified form as a prelude to the more detailed description that is presented later.

An architecture that facilitates transmitting customized data feeds from a platform data warehouse to one or more clients to which the data relates is provided where the client requests subscription to the feed and/or creates the feed, for example. The platform can store a large amount of data in the data warehouse pertaining to transactions related to specific clients of the platform, for example. A client can desire access to the data and can request a local copy of a feed from the platform such that the client can create customized applications and/or services that add value to the data. In this regard, the client need not rely on the platform to expose the specialized methods or services. Additionally, significant burden can be removed from the platform as requests for data access can become localized to the client; moreover, storage of the data related to the platform can be off-loaded to the client to mitigate space constraints at the data warehouse level.

In one embodiment, the platform can be a service-based platform, for example, where the platform offers a service to clients such that service transaction data can be useful for billing purposes. To this end, tracking the data can be beneficial for both the service (for billing purposes) and the client to ensure status in regard to a level of service, for example. In this embodiment, the client can subscribe to the platform to receive a data feed of a portion of the data stored in the data warehouse, for example the data relates to transactions on the platform related to the client. The platform can process the subscription request according to a number of factors, including authorization for the feed(s) and/or field(s) requested, system policies, etc., and transmit the requested feed to the client based on a time interval, for example. In this regard, the client receives the portion of the feed related to the request and can analyze, manipulate, store, and backup, for example, this data by providing an interface, application, and/or web-service over the data. Thus, processing burdens regarding the data are mitigated on the platform.

To the accomplishment of the foregoing and related ends, certain illustrative aspects are described herein in connection with the following description and the annexed drawings. These aspects are indicative of various ways which can be practiced, all of which are intended to be covered herein. Other advantages and novel features may become apparent from the following detailed description when considered in conjunction with the drawings.

### BRIEF DESCRIPTION OF THE DRAWINGS

FIG. 1 illustrates a block diagram of an exemplary feed distribution architecture.

FIG. 2 illustrates a block diagram of an exemplary feed distribution architecture and requesters.

FIG. 3 illustrates a block diagram of an exemplary feed manager.

FIG. 4 illustrates a block diagram of an exemplary feed distribution architecture in conjunction with a service platform architecture.

FIG. 5 illustrates a block diagram of an exemplary hierarchical feed distribution architecture.

FIG. 6 illustrates an exemplary flow chart for requesting a data feed.

FIG. 7 illustrates an exemplary flow chart for processing a request for a data feed.

FIG. 8 illustrates an exemplary flow chart for replicating feeds.

FIG. 9 is a schematic block diagram illustrating a suitable operating environment.

FIG. 10 is a schematic block diagram of a sample-computing environment.

### DETAILED DESCRIPTION

An architecture for distributing data feeds relating to service data of a platform is provided where platform clients can receive local copies of relevant data feeds to remove processing burden from the platform and allow the clients to utilize the data feed to create custom views of associated data. Storing the feed data only in the data warehouse of the platform results in accessibility to the data only by exposed interfaces and/or services (such as web services, for example). The interfaces and/or services are limited in providing information about the data feed as implemented, and where a platform supports numerous clients, constant specialized access to the data warehouse can become burdensome. Thus, moving the feed data from the data warehouse in which it is stored to remote client databases allows the client to define custom services/interfaces and/or applications for data viewing and analysis, and also takes much of the burden from the platform at least since shipping entire data feeds to the client takes minimal processing power as compared to processing constant queries of the data.

In one embodiment, the platform can be service based such that clients can utilize the service platform, and data regarding usage can be maintained for purposes such as accounting (where the platform is monetized, for example), error tracking, usage pattern determination, and the like. While much of this data is important to the service provider, it can also be important to the client. For example, a web conferencing service provider can keep data regarding minutes of use where the client is charged per minute—this information is important to both the provider for accounting purposes as well as the client. Additionally, the same data can be important in other systems such as a cellular phone service provider and subscriber/client for example. Constantly hitting the platform for requests from the client can become burdensome where the platform has a large client-base. In some cases, the service platform can provide service to a number of partners who forward service on to their own clients (such as an outsourcing scheme). In addition, data is relevant on all three layers as well (service platform, partner, and client). In this scheme, feed distribution is desirable as well since the partner can provide valued views of the data feed distributed to its local platform as compared to keeping the data on the service platform and only having access to data services predefined on the platform.

Various aspects of the subject disclosure are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents and alternatives falling within the spirit and scope of the claimed subject matter.

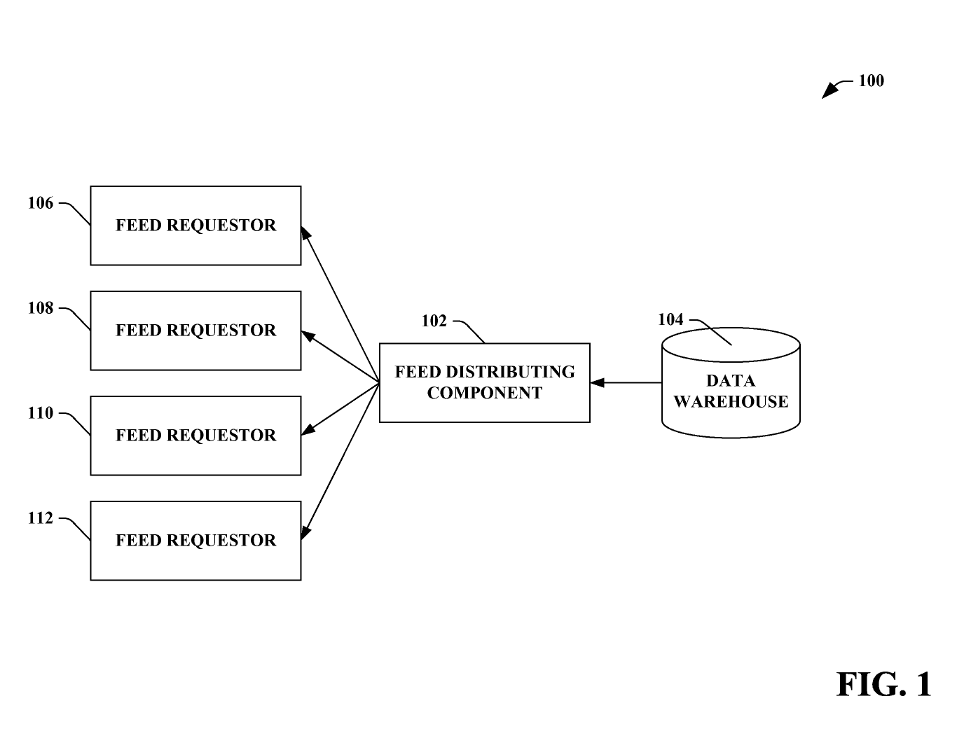

Now turning to the figures, FIG. 1 illustrates a system 100 that facilitates distributing data feeds. A feed distributing component 102 is provided to distribute feeds to at least one feed requester, a data warehouse 104 is also shown that houses data related to a platform, and a plurality of feed requestors 106, 108, 110, and 112 are additionally illustrated. In one embodiment, the data warehouse 104 houses data related to a platform (such as a service platform, for example), and the feed manager 102 receives and distributes the data to the plurality of feed requestors 106, 108, 110, and 112. It is to be appreciated that the feeds can comprise the same or disparate data; the feed structure can be defined according to specification by the feed requestor 106, 108, 110, and 112, or a component associated therewith.

The data warehouse 104 can store data in conjunction with a service-based platform, for example, where the platform provides the service to one or more clients. The data can relate to usage in many respects, such as component usage, content usage, overall system usage, usage by time, usage by data size, connection speed, data transfer rates, and the like. The data can also relate to specific system functionalities, such as methods utilized, results, error codes, satisfaction with certain components (by survey, for example), commonly requested methods (such as for a given user, a group of users, or all users, for example), time spent using certain methods or components, etc. Data can additionally be stored regarding accounting parameters for given user accounts where the platform is monetized, such as account status changes, account level changes, billing (such as statements and bill payment), account balance change, and the like. It is to be appreciated that these are just examples of possible platform data stored in a data warehouse 104, and the subject matter disclosed herein is not so limited to the foregoing. In fact, a platform in accordance with the subject matter as described can have some, none, or substantially all of the foregoing data values stored, as well as others not explicitly mentioned. Moreover, the data warehouse 104 can be a relational database and/or a hierarchical database (such as one or a plurality of extensible markup language (XML) files). Also, the data warehouse 104 can be flat-file, comma-separated and the like.

The feed requestors 106, 108, 110, and 112 can be disparate systems, platforms, data stores, etc. that desire to receive data feeds corresponding to data in the data warehouse 104. The feed requestors 106, 108, 110, and 112 can each be different types of systems, platforms, data stores, and the like, and indeed, can be remotely located from the data warehouse 104, the feed distributing component 102, and/or themselves. In fact, the feed requestors 106, 108, 110, and 112 can have no relation to one another other than that they all receive service from the platform to which the data warehouse 104 relates. In one embodiment, a feed requestor 106 initially registers with the feed distributing component 102 to receive one or more data feeds relating to the service provided by the platform to the given feed requestor 106. Following registration, the feed distributing component 102 can setup a feed for a portion of the data in the data warehouse 104 can submit the feed to the feed requestor 106. Another feed requestor 108 can request access to the same or a completely different data feed related to the service it is provided by the platform. After request/registration, the feed distributing component 102 can begin to submit the requested feed to the feed requestor 108. The feed distributing component 102 can handle both feeds to feed requestors 106 and 108 as well as any additional feed requests (such as those that can be requested by feed requesters 110 and 112, for example). It is to be appreciated that the registration process can involve a number of steps and components, such as authorization if desired; this is described in further detail infra.

After requesting the data feed, the feed requestors 106, 108, 110, and 112, can receive the requested feed from the feed distributing component 102. The feed requesters 106, 108, 110, and 112 can store the received data in a separate data store or data warehouse, for example, and perform a number of analysis and/or access routines on the data. The routines can also be performed in connection with requests from clients of the feed requesters 106, 108, 110, and 112. Such routines can include substantially limitless routines that utilize and manipulate the data; some brief examples are routines to gather usage statistics for a given user or group (such as those mentioned supra), data regarding commonly accessed portions of the platform, and the like. By pulling the feed from the platform to the client, more granular access to the data is facilitated by any number of access routines implemented on the client. Additionally, processing burden for multiple requests regarding different views of the data from a plurality of users is moved from the platform to the client, thus, freeing up the platform to commit processing time to other aspects of the platform, for example. It is to be appreciated that the data feeds can be transmitted from the feed distributing component 102 to the feed requesters 106, 108, 110, and 112 on a time basis and/or on an event driven basis such that when modifications are made to the feed at the platform end, the feed is sent to the requestor (this can vary on many factors as well, for example, such as number of modifications or new events, events from certain users, events of certain types, etc.).

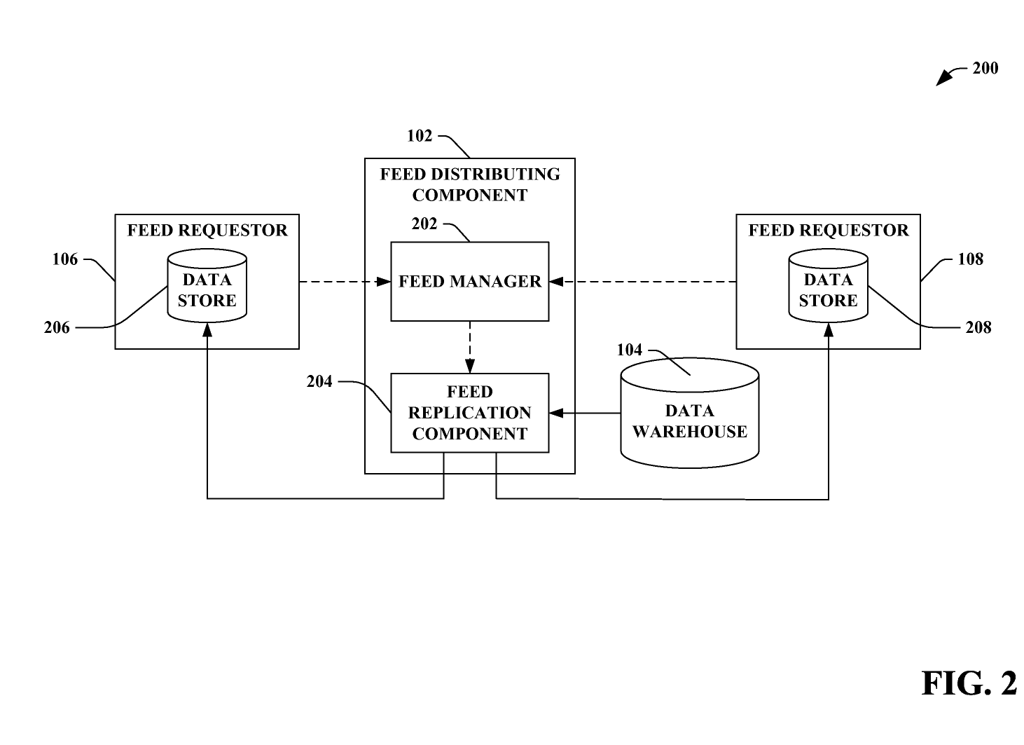

Referring to FIG. 2, an example system 200 that facilitates distributing requested feeds is illustrated. A feed distributing component 102 is provided comprising a feed manager 202 that controls aspects of requested feeds and a feed replication component 204 that transmits the feeds to the requesting entities. Additionally, a data warehouse 104 is provided that stores data related to a platform (such as service data for example) as well as feed requesters 106 and 108 having respective local data stores 206 and 208 that store the feed data. In one embodiment, the feed requesters 106 and 108 request data feeds from the feed manager 202 of the feed distributing component 102. The feed manager 202 processes the request for the data feed and leverages the feed replication component 204 to initialize and send the requested feed to the feed requesters 106 and 108. The feed requestors 106 and 108 can store the data feeds within their respective local data stores 206 and 208 for analysis, manipulation, and/or backup, for example.

The feed manager 202 can be employed to manage a plurality of feeds requested by one or more feed requesters 106 and 108. It is to be appreciated that more than one feed can be requested by a single feed requestor 106 or 108; the feed distributing component 102 can distribute them separately and/or consolidate the feeds into one larger feed. The feed manager 202 can be used to add, delete, or otherwise modify the requested feeds. The feed manager 202 can also provide interfaces to perform the foregoing management tasks as well as to list feeds and monitor them as well. For example, the feed manager 202 can display a status relating to one or more feeds, such as active, disabled, locked, etc. Moreover, the feed manager 202 can query the type of data available in the data warehouse 104, provide options for data aggregation, and specify policy restrictions for a given feed requestor 106 and 108, or a user utilizing such for example. Also, by providing management of the feeds where the feeds can be a portion of the entire feed in the data warehouse 104, the feed manager 202 can lower cost of delivering the data to the feed requestors 106 and 108 as only certain data is needed by the requestors 106 and 108, and in this regard, the feed manager 202 also allows the data to be delivered to a large number of customers (or requesters 106 and 108). The feed manager 202 will be described in greater detail infra.

In one embodiment, the feed manager 202 can handle requests for feeds from the feed requesters 106 and 108. Requests for setup can entail leveraging the feed replication component 204 to initialize and start the feed. The feed replication component 204 gathers data from the data warehouse 104 for submission to the feed requesters 106 and 108. The data can be related to a service, as described above, such as where tracking data can be important to a user or feed requestor 106 and 108, resulting in constant requesting of such data such that the data can be more efficiently located locally to the requestor 106 and 108. The data can comprise large amounts of logging data for the service, for example, such as transaction-level entries in the platform. In a multi-user service platform, this amount of data can scale quickly and become a nuisance for the service platform in regard to storage and management alone, much less querying of the data. Thus, the described subject matter aims to ease these burdens by allowing the large amounts of data to be off-loaded from the data warehouse 104 to disparate feed requestors 106 and 108 where the data can be subsequently stored, managed, and analyzed/accessed.

The feed requesters 106 and 108 can be disparate systems, remotely located and can have disparate architectures. Additionally, the respective data stores 206 and 208 can have disparate architecture (such as relational, hierarchical, flat-file, etc.). Moreover, the feed requestors 106 and 108 can request and receive disparate data feeds corresponding to the service provided to them by the platform. It is to be appreciated that the system architectures, locations, and/or data store architectures can be the same for both requestors 106 and 108 as well. Once the feed requestors 106 and 108 have the data in the respective data store 206 or 208, the feed requestors 106 and 108 can implement routines and applications to display or otherwise utilize (such as programmatically, for example) the data from the feed. Moreover, the data can come from the data warehouse 104 with a schema describing the layout. The data can be transmitted from the data warehouse 104 to the feed requesters 106 and 108 in substantially any format, including log shipping (such as available in SQL) or other binary format, XML, flat-file, comma separated value (CSV) file, tab-delimited, etc. It is to be appreciated that other technologies that can emerge are supported in this regard.

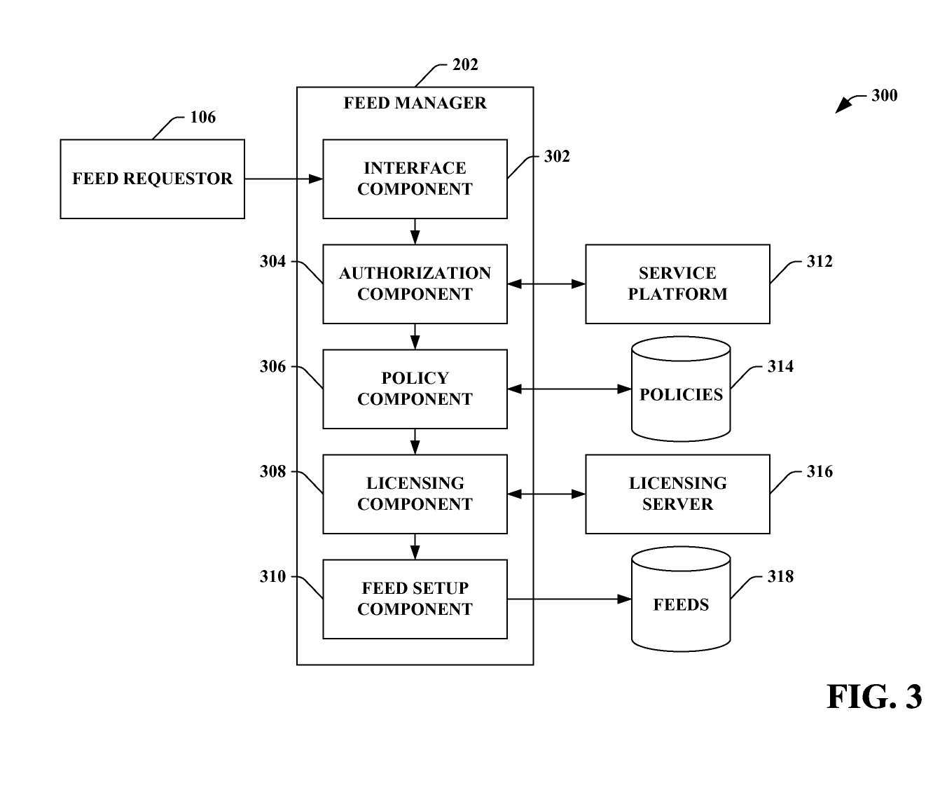

Turning now to FIG. 3, an example system 300 that facilitates requesting a feed is shown. A feed manager 202 is provided comprising a plurality of components, including an interface component 302 that provides an interface for managing feed access, an authorization component 304 that authorizes access to aspects of the feeds, a policy component 306 that can enforce policies regarding the feed access, a licensing component 308 that can impose licensing scheme(s) to the access, and a feed setup component 310 that completes setup and/or initialization of the feed. Additionally, a feed requester 106 is provided to request the feed, a service platform 312 to which a portion of the feed data can relate, a policies database 314 that can house policies used as described, a licensing server 316 to define licensing schemes or other aspects, and a feeds database 318 that can house the feeds to be delivered by a feed replication component.

In one embodiment, the feed requester 106 requests a data feed from the feed manager 202 via the interface component 302. The feed manager 202 can employ an authorization component 304 to authenticate the user on the service platform 312 where the data feed relates to data from the service platform 312. The authorization component 304 can also leverage the service platform 312 to determine if the requestor 106 (or a user utilizing such) is authorized to access the feed requested, or a portion thereof. Additionally, the policy component 306 can ensure the request complies with one or more policies in the policies database 314. The licensing component 308 can be used to check for any licensing issues regarding the request by leveraging the licensing server 316, and the feed can be finalized and setup by the feed setup component 310, which stores the completed feed setup in the feeds database 318 for subsequent use by a feed replication component.

The interface component can provide a graphical user interface (GUI) to a feed requesting entity (such as a user or feed requestor 106) to facilitate feed setup. For example, the GUI can list available feeds, such as by alias, and/or available fields to create custom feeds, for example, by selecting desired fields relating to the service. The interface component 302 can create the interface, for example, based on a data warehouse scheme for the data relevant to the requesting entity. Fields and/or selection can also be provided for frequency of the feed updates (and/or type, such as periodic or event-based and if event-based, on what), format of the feed (relational, SQL, log shipping, XML, CSV, flat-file, etc.), formats for times and dates, and the like. It is to be appreciated that the GUI can use artificial intelligence, or other evaluation scheme, to populate the interface to put commonly requested schemes and/or fields first, for example. The interface component 302 can additionally or alternatively provide an application program interface (API) having similar options or a web-service, for example, such that no human intervention is necessarily needed to setup the feed. The API or web-service can allow an application to programmatically setup a feed according to specification of the values such as those mentioned above. The API or web-service can also provide querying functionality for the application to obtain information regarding aggregation options available, formats available, and other specifics about the feed distributing component. The interface component 302 can additionally provide for feed setup, deletion, and monitoring, for example, where feed status can be obtained and provided from the feed manager 202 as well. Moreover, monitoring statistics can be recorded such as the amount of feed data requested for a given time period, as well as number of requests, throughput, size of data, and the like. The interface component 302 can also expose information regarding the data and/or the feed manager 202 generally (as metadata for example), such as expiration time for data, creation date of the feed, time of next feed, number of feeds stored, and the like. Additionally, the interface component 302 can employ artificial intelligence or another deterministic technique, for example, to track requests made from the requestor 106 outside of the feed system and offer data related to significant requests be included in the feed. This can occur at feed setup and/or during feed management.

The authorization component 304 can ensure the feed requestor 106, or a user utilizing the requestor 106, is authenticated to use the service to which the feeds relate by leveraging the service platform 312. It is to be appreciated that the data warehouse can be located on or proximately to the service platform 312, but the platform can be responsible for the data stored in the data warehouse. The service platform 312 can have an authorization/authentication system to ensure the user can access the platform in the first place, and this system can be leveraged by the authorization component 304 to authenticate the user or requestor 106. Additionally, the authorization component 304 can utilize the service platform 312 to ensure the user is authorized to access the data in the feed requested. It is to be appreciated the this step can occur once the user or requestor 106 requests the feed be created, or the interface component 302 can present only the fields and/or feeds to which the user or requester 106 is authorized by leveraging the authorization component 304. Moreover, the authorization can take place in comprising the feed for delivery, for example, where the main feed has mixed client data—the client data for the authorized feed requester can be extracted before transmitting the feed. It is to be appreciated that the authorization component 304 can handle many authorization concerns between the user or requestor 106 and the data for which the service platform 312 is responsible. Other policies regarding data, such as the data of the feed manager, can be handled by the policy component 306.

The policy component 306 can enforce one or more policies related to the data as defined in the policies database 314. Such policies can include those relating directly to the feed manager 202 such as number of feeds that can be requested, the amount of total data that can be requested, minimum time and/or size of a feed request, frequency of the feeds (or other protections), etc. Additionally, the policies can relate to the scope of the data in the feed as well as types of data and aggregations thereof (e.g. average users can be allowed aggregated data that makes sense to a user whereas a partner to the service platform 312 provider can access raw data and error logs as well). It is to be appreciated that the policies can be defined per user or group, for example, such that the feed manager 202 can be monetized by offering more performance to higher paying clients or requestors 106. Moreover, this can also be implemented in the data field realm where more fields are available in the data feed for more money, for example. In addition, the policies can be time- and/or interval-based such that higher paying users can get data more frequently and data relating to a larger span of time, for example. Similarly, the licensing component 308 can provide licensing schemes as defined in a licensing server 316. In this regard, requesters 106 (such as partners or clients) can purchase different levels of data access (such as standard, pro, etc.) and receive data corresponding to that level. Additionally, the licensing component 308 can handle other licensing issues such as numbers where the requester 106 (or group in which the requestor 106 participates) has a limited number of licenses. In this regard, access to the feed can be denied where all licenses are being used. All the licensing and monetization aspects can be evaluated after requests or implemented within the interface component 302 to show only the options to which the requester 106 has paid for or has licenses for. Additionally, the interface component 302 can show other options and indicate that they are available only in upgraded versions and provide a link to upgrade, for example.

The feed setup component 310 can complete the feed setup if the other components that can be employed indicate setup is allowed. It is to be appreciated that the other components need not be employed in the subject matter as disclosed herein; rather, all, some, or none can be used. Once the feed is setup, the feed setup component 310 defines the feed in the feeds database 318 for subsequent use by a data replication component that can submit the feed to the destination requested by the requestor 106 in the interface component 302, for example.

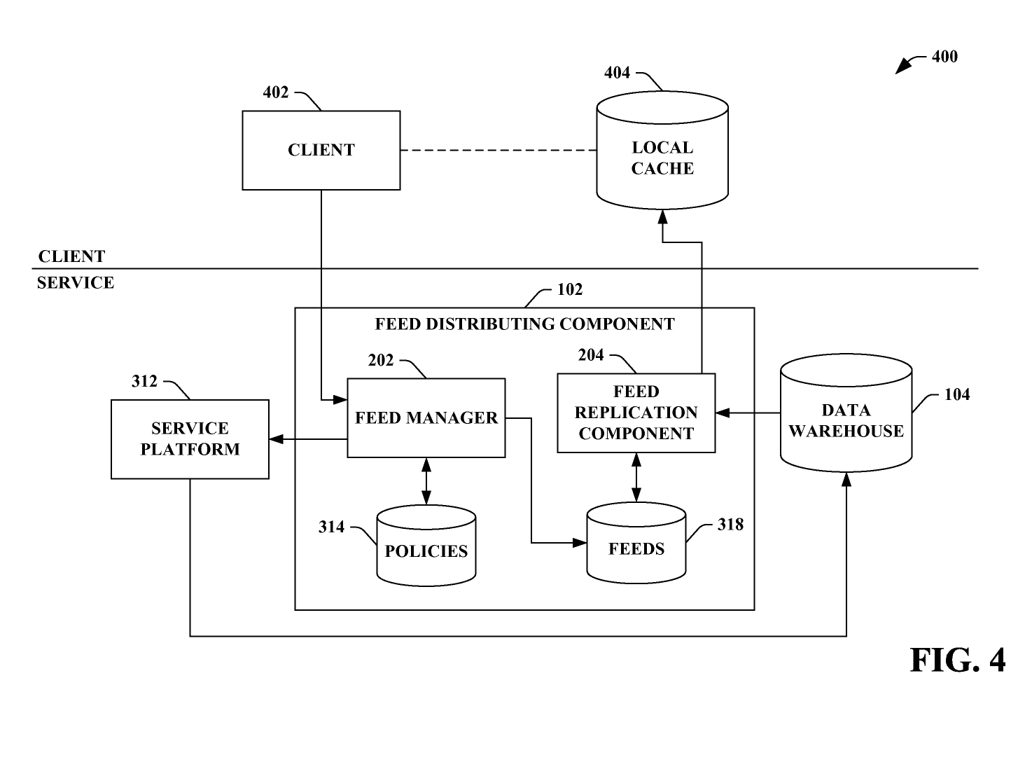

Turning now to FIG. 4, an example system 400 that facilitates utilizing feed distribution in a service-oriented architecture is displayed. On the service side, a feed distributing component 102 is provided comprising a feed manager 202, a feed replication component 204, a policies database 314, and a feeds database 318. Additionally, a data warehouse 104 is provided that stores large amounts of service data (such as logging/tracking data) related to a service platform 312, also provided. On the client side, a client 402 is provided that registers for a data feed, and a local cache 402 that receives the data feed. In one embodiment, the client 402 requests a data feed from the feed manager 202. The feed manager 202 can process the request by requesting authorization from the service platform 312 to ensure the user is authenticated and authorized for the feed and/or data within the feed requested. The feed manager 202 can continue by checking the policies database 314 to ensure the feed requested complies with relevant policies (such as specific to the client 402). If this all checks out, the feed can be created and stored in the feeds database 318. The feed replication component 204 can subsequently process the feed delivering the feed data to the client-side local cache 404 where the data can be subsequently analyzed, stored, and manipulated. It is to be appreciated that this process can be independent of the registering, such that the feed replication component 204 does not know when, why, or how the new feed was added; rather, it just goes about processing the feeds in the feeds database 318.

The feed requested by the client 402 to the feed manager 202 can be for specific types of data at specific granularities; the data feed can also be related to a one or more users or accounts. The feeds can be of all sorts, such as on-demand, pushed, binary, XML, relational, flat-file, raw data from the data warehouse, etc. Once the data feed is downloaded to the local cache 404, the client 402 can run queries/reports against the data or utilize custom applications to view, analyze, and/or otherwise manipulate the data. Additionally, the client 402 can be responsible for backing up the data, which can free space on the service platform 312 and data warehouse 104 since they can essentially off-load the data to the client 402 via the local cache 404. In this regard, as described previously, the data feed can be transmitted with a schema so the client 402 knows what data is being transmitted and its layout. Additionally, the schema can self-describe the data in such a way as to permit application development with the data feed without requiring recompilation for addition of data and/or fields to the data feed.

In one embodiment, for example, the service platform 312 can be a provider such as a cellular telephone service where service is remotely provided to a plurality of cellular phone users. The service comprises cellular network access to facilitate receiving and establishing telephone calls. The service can be tracked by a number of minutes used by a cellular phone user, and the user billed accordingly. Status checking of minutes can be desired by the user via client 402, which can be a computer and/or cellular phone, for example. At this granular level, the described subject matter may not be of great benefit, however, the user can be participating in an extremely large group plan (such as a company phone plan) having thousands of users, for example. Additionally, the company can bill plan users for any overages in minutes that are not covered by the company. In this regard, the company can be the client 402 and can desire local access to data from the cellular phone service platform 312, and indeed, the service platform 312 can desire to give the company client 402 access to the data to off-load the data and allow the company to field usage report requests from the users of the company plan.

In this embodiment, the company client 402 can request access to a data feed from the feed manager 202, specifically a data feed relating to each plan user's usage (which can be as simple as number of minutes used to as complex as each transactional detail). The feed manager 202 can leverage the service platform 312 to authenticate the company, ensuring it is a client. Additionally, the feed manager 202 can leverage the service platform 312 to ensure the company is authorized to access the data requested in the data feed (e.g. that it would be able to access the data normally, for example). It is to be appreciated that the authorization rules can change in real-time and be evaluated as the feed is being transmitted to the client 402, for example if laws are enacted that provide restriction on the personal data the company can access. The feed requested is additionally checked against the policies database 314 to ensure all policies are complied with. For example, if the partner is requesting too many feeds or feeds to frequently (such as more than was paid for, for example), the request for the feed can be denied or conformed to an acceptable feed request. Once the feed is ready, it is placed in the feeds database 318 where it is subsequently picked up by the feed replication component 204, processed according to the data in the data warehouse 104, and submitted to the local cache 204. Once the data is in the local cache 204, it can be utilized to run reports, for example overages billed out to the users. Additionally, applications can be written to access the data, such as to provide usage information to the users, for example. Additionally, the data can be backed up at the company end. Thus, significant burdens are removed from a service platform 312 with respect to data access, manipulation, and storage/backup.

In another embodiment, for example, the service platform 312 can be a web conferencing service provided to a plurality of partners such that the partners can provide individualized services to their own clients. For example, the web conferencing service can provide for communication amongst a plurality of users and collaboration functionality as well (where users can share and collaborate on documents, for example). The service can be provided on a service platform 312 and partners can provide access to the service through the service platform 312; to this end, the partners can build applications on the service platform 312 as well. In this embodiment, the partner is the client 402 and can desire access to data in the data warehouse 104 regarding functionality provided by the partner to a plurality of its clients. For example, the data in the data warehouse 104 can be valuable to the partner and also the service provider as the service provider can bill the partner based on usage. Thus, both the partner and the service provider have an interest in the data; however, the partner may want more granular access to the data than is needed by the service provider. For at least this reason, transmitting the data feed to the partner as well can add value to the data in this regard.

In this embodiment, the partner client 402 can request subscription to a data feed from the feed manager 202 to obtain a local copy of the feed for subsequent access, manipulation, and the like; the data feed relates to the service provided to the partner. This gives the partner ultimate flexibility in the use of the data. In this regard, the client 402 can provide the same functionality to its clients, breaking the feed down into additional client concentrated feeds; this will be described further infra. The feed data can relate to specific data at specific granularities or general data regarding the partner's usage (or usage by others through the partner), for example, or substantially any combination of available data. Examples of data in the web conferencing/collaboration service context are raw information regarding connect and disconnect events by clients, visitor information regarding the time of entry/exit of given visitors, meeting information (such as start/end time, max attendees, attendee minutes, etc.), organizer information regarding the meeting (such as breakdown of meeting usage, number of meetings, maximum attendees, attendee minutes, etc.), and call-center information about a specific call-center within the web conferencing environment (such as per call-center breakdown of meeting usage, number of meetings, maximum attendees, attendee minutes, etc.), and the like. The feed can be requested by feed and/or field selection, for example via a GUI, or programmatically such that human intervention is not required. As part of the feed request/setup, authorization is checked for the partner client 402 to ensure it is authenticated to use the service platform 312 in general and that it has access to the feed and/or data fields requested; this can also be done at the platform 312 level and/or at the policies database 314. For example, access to feeds can be kept in the policies database 314, for example, while access to certain fields can be determined by accessing the service platform 312. Moreover, the plurality of fields in the feed can be checked against the service platform 312 to bypass the policies database 314 access. Additional policies can also be checked in this regard, such as those related to the feed distributing component 102 itself. The policies in the policies database 314 can relate to this aspect of the subject matter such that protective policies regarding the integrity of the feed distributing component 102, as well as policies regarding a level of access granted to a client 402 can be checked for compliance. For example, a policy regarding the number of feeds distributable by the feed distributing component 102 can be employed to ensure the feed distributing component 102 does not exceed a capacity and move to a failing state. Additionally, the policy can relate to a number of feeds a partner can access given a level of paid service. To this end, where the partner desires additional access, a link to upgrade the level of service can be provided. Moreover, licensing services can be used in this regard as well to indicate a level of service and/or a number of licenses available. The licensing information can be obtained from a separate source or from the service platform 312 and/or setup in the policies database 314 for example. If the feed is permitted in the foregoing regards, it is setup in the feeds database 318.

Subsequently, the feed replication component 204 runs the feeds in the feeds database 318 by utilizing the data warehouse 104. It is to be appreciated that this process can be independent from the feed registration process. The feeds in the feed database 318 can have information regarding the feed to enable the feed replication component 204 to run the feed. For example, such information can include a destination for the feed (which can include a backup destination as well, for example), a frequency for feed transmittal (or an event causing transmittal if the feeds are event-driven, for example), the data requested, a data format (such as SQL log shipping, or other binary format, XML, CSV, flat-file, etc., and/or other technologies that may emerge in this regard), feed type (such as on-demand or pushed according to an interval), and the like. It is to be appreciated that the feed replication component 204 can support a plurality of formats; the available formats are exposed to the client 402 out of the feed manager 202 (and/or the interface thereof) at feed setup time. Utilizing this information, the feed replication component 204 packages the feeds in the format desired and sends the feed to the local cache 404. It is to be appreciated that some authorization can be implemented at this level to account for changes in permissions with respect to the data accessible by the client 402. It is also to be appreciated that where data for multiple clients is consolidated in a data store, the feed replication component 204 can be responsible for separating the data out before transmitting to the appropriate client's 402 local cache 404. Following feed setup, the client 402 can execute applications relating to the data requested and stored on local cache 404. Once on the local cache 404, the data belongs to the client 402 and substantially any applications and/or services can be implemented in regard to the data; in this way, the data can be schematized so the local cache 404 and/or the client 402 can know how the data is formatted from subsequent storing and/or analysis. Moreover, once set up, the partner client 402 can access the feed manager 202 to monitor the feed with respect to a number of different statistics/variables. For example, the average time for transmission, average size, cost, etc. can be monitored and the client 402 can fine-tune the feed via the feed manager 202 to meet its needs. Additionally, the feed can be deleted through the feed manager 202 as well. It is to be appreciated that there can be multiple feed managers 202 in a given embodiment and/or multiple feed distributing components 102 all together. Additionally, there can be multiple platforms 312, data warehouses 104, databases 314 and 318, and clients 402 and local caches 404 alike. Moreover, the disparate components can be distributed across a network, such as the Internet.

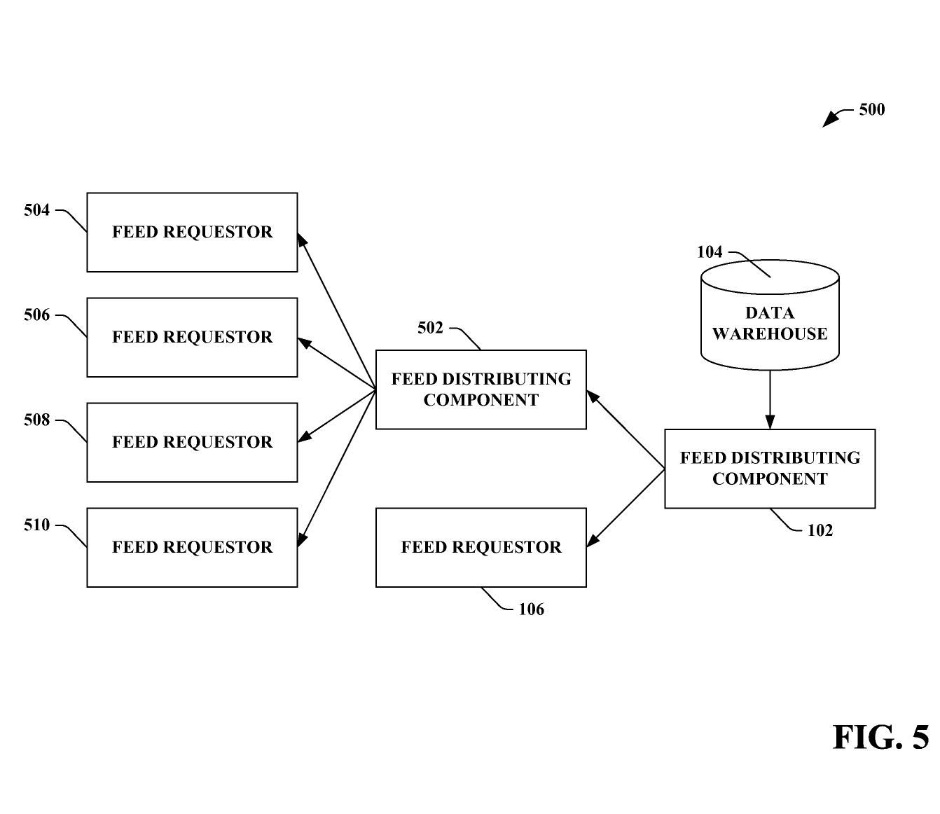

Referring now to FIG. 5, an example system 500 for providing multiple hierarchical distributions of feed data is shown. A feed distributing component 102 is provided along with a data warehouse 104 that houses data related to a platform and a feed requester 106 that requests at least one data feed from the feed distributing component 102. Additionally, another feed distributing component 502 is provided that requests at least one feed from the feed distributing component 102, and a plurality of feed requestors 504, 506, 508, and 510 request feed data from the additional feed distributing component 502. In one embodiment, feed requestor 106 and additional feed distributing component 502 request a data feed from the feed distributing component 102. The feed distributing component utilizes the data warehouse 104 to initialize the feed and transmits the feeds to the feed requestor 106 and feed distributing component 502, such as on an interval basis, for example. Subsequently, feed requestors 504, 506, 508, and 510 can request a portion of the feed from feed distributing component 502; feed distributing component 502 transmits the requested feeds to feed requestors 504, 506, 508, and 510.

The feed distributing component 502 can be, for example, at a partner site as described herein; specifically, it can be the local cache of previous figures allowing both local access of the data as well as access requests to feed data from other users, clients, and/or partners of the partner. In this regard, the feed distribution can be hierarchical. In particular, the feed distributing component 502 can be substantially similar to feed distributing component 102 shown in previous figures, able to field requests for feeds and transmit the requested feeds based on interval, event, and/or on-demand. For example, using the web conferencing example above, the partner can desire to bill clients for access to its system that accesses the initial service provider; thus tracking information can be desired by the clients as well to track usage for budgetary purposes, for example. Thus, the clients (or feed requestors 504, 506, 508, and 510) can request access to feeds from the feed distributing component 502; the feed data is downloaded to the client's local cache. Thereafter, the client can access the local cache information via application and/or service to obtain desired information. In this embodiment, the feed distributing component 502 can be responsible for splitting the data feed appropriately where data for all the requesters 504, 506, 508, and 510 is consolidated into the single feed received from the feed distributing component 102. The hierarchical levels can be separated, however, since the data feed is transmitted from the platform to the partner, the data becomes the partner's and the partner is responsible for any functionality offered, such as further distribution to client feed requestors 504, 506, 508, and 510 as shown. Additionally, it is to be appreciated that feed requestors 504, 506, 508, and 510 can effectuate change in the data feed requested by the feed distributing component 502, for example, where the feed distributing component 502 offers additional fields to the feed requestors 504, 506, 508, and 510 for use that are not currently in the feed but to which the feed distributing component 502 has access. It is to be appreciated that the feed distributing component 502 does not need a local data store; rather the data can be requested by one or more feed requestors 504, 506, 508, and 510, the feed distributing component 502 can request and receive the relevant data from feed distributing component 102, and the data can subsequently be delivered directly to the requester from the feed distributing component 502. Additionally, the requested data can undergo data checking at the feed distributing component 502, such as for conformity with a policy for example, before it is sent on to the feed requestor(s) 504, 506, 508 and/or 510.

The aforementioned systems, architectures and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, as will be appreciated, various portions of the disclosed systems and methods may include or consist of artificial intelligence, machine learning, or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent, for instance by inferring actions based on contextual information. By way of example and not limitation, such mechanism can be employed with respect to generation of materialized views and the like.

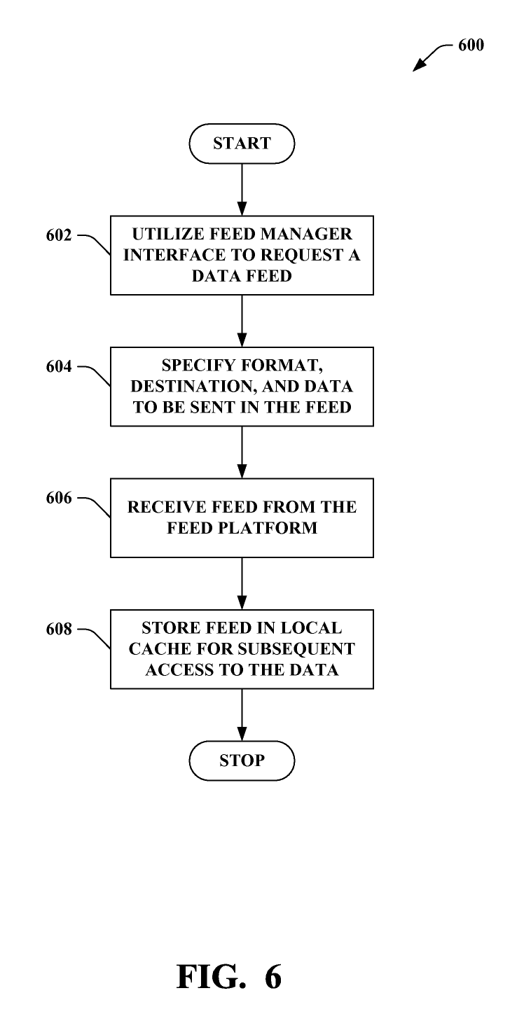

In view of the exemplary systems described supra, methodologies that may be implemented in accordance with the disclosed subject matter will be better appreciated with reference to the flow charts of FIGS. 6-8. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 6 illustrates a methodology 600 for requesting a data feed from a feed manager. At 602, the feed manager interface is utilized to request the feed. The interface can display a list of available feeds and/or fields where the interface is a GUI; additionally, there can be a level of authorization/authentication regarding using the system and/or the data fields requested. In one embodiment the interface is created around the authentication/authorization functionality such that only data to which the requesting entity has access are shown as options. Additionally, the interface can be an API or web-service used to programmatically request data feed access from the feed manager. At 604, feed format, destination and data requested are specified. The feed format can be any format supported by the manager, such as log shipping, flat-file, XML, CSV, or many other hierarchical, relational, or flat formats; the feed can support additional formats that may emerge as well. The destination can be a remote destination to any device or application that can accept the data feed, for example.

Once the feed format is setup and specified, the feed can be monitored with respect to status and/or a number of statistics associated with the feed to analyze throughput, for example. At 606, the feed is received from the feed platform and stored in local cache for subsequent access at 608. As described, the subsequent access capabilities are virtually limitless as the data is now sitting locally on the requesting entity's site. To this end, the subsequent access can be a further hierarchical distribution of the data to a plurality of clients of the requesting entity as described supra. Moreover, the access can be reporting, inquiry, storage, and/or backup of the data as desired by the requesting entity.

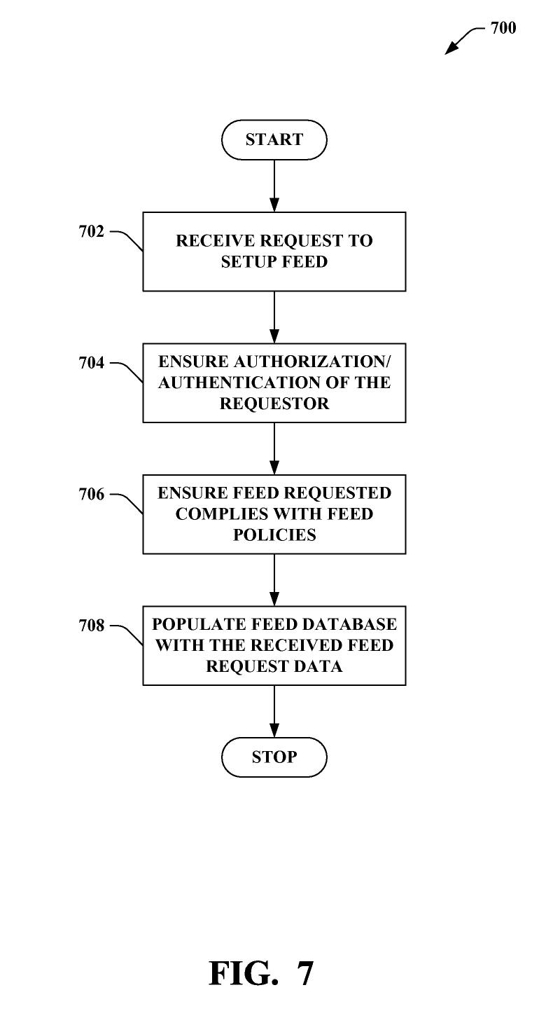

FIG. 7 displays a methodology 700 for setting up a requested feed for transmittal, for example in a feed manager. At 702, a request for feed setup is received; the request can comprise a plurality of information regarding the feed such as data fields and/or feed(s) requested, destination for the data feed, interval, format (such as those described herein, log shipping, XML, CSV, flat-file, etc.), and the like. In one embodiment, a simple request can be received expressing desire to setup a feed, and an interface can be developed around the request to provide data according to other factors; for example authorization can be pre-checked for the requestor and only feeds and or data fields to which the user has access can be display, etc. Additionally, the feeds and or data fields can be limited to those the requestor has purchased, according to a license level, for example, and the other currently unavailable options can be displayed with a link to upgrade for example to receive the options. At 704, authentication/authorization is checked against the requestor to ensure that they are authenticated on the system for which the data feeds are replicated; additionally, authorization in regard to the data fields and/or feeds requested can be ensured. If the requestor cannot access the requested data and/or feeds, the feed construction can be halted and error sent to the user, for example. Additionally or alternatively, a feed can be setup as close to the request as possible leaving out the unauthorized data.

At 706, the feed request is checked against policy considerations. These can relate to policies concerning the feed distributing functionality and/or based on specific users, accounts, requesters, etc. The policies can be established regarding, for example, maximum number of feeds, maximum data throughput, etc.; additionally, the policy can be enforced at a user level as well such that users can only exceed the policy thresholds by upgrading. As described, where a feed request does not comply with a policy, information can be sent to the user indicating that an upgraded version would allow the feed and a link to upgrade can be sent as well, for example. At 708, the feed request data is populated in the feed database where it can, for example, be leveraged by a feed replicator to transmit feeds to the requester. The data populated in the feed database can be, for example, data relating to destination for the feed, format desired for the feed, compression method desired, data requested in the feed, feed interval, and the like.

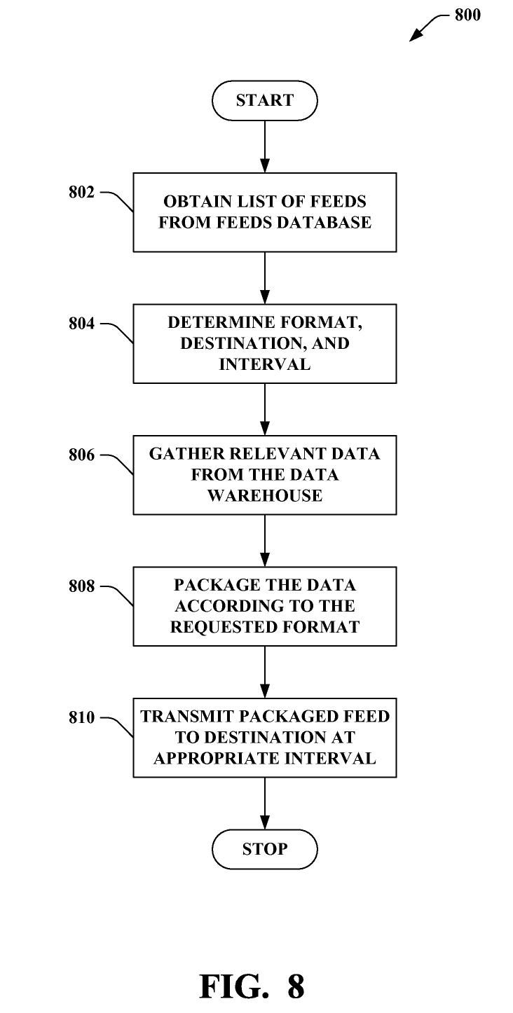

FIG. 8 illustrates a methodology 800 for replicating feeds according to feed entries in the feeds database. At 802, a list of feeds is obtained from the database; in particular, the list can include information about the feed such as format to transmit (such as log shipping, XML, flat-file, CSV file, etc.), transmission intervals and/or events causing transmission, destination, data requested (feeds and/or fields, for example), and the like. At 804, the format, destination, and interval are determined; these will be used in the transmission of the data feed. At 806, relevant data is gathered from the data warehouse; this can be data related to a service provided by a platform, for example. The data can include substantially any data related to transactions in the platform; in the service context, such can include transactions by a user and timing thereof, resources accessed, and/or any data that relates to a monetized element of the platform. Additionally, the data can be stored in substantially any format, such as relational database, hierarchical database or document (such as XML, for example), flat-file, and the like. After relevant data is gathered, it is packaged at 808 according to the format requested by the feed requester as indicated in the feed database. The format can be at least one of many, as described, and can further specify compression method for the data (after packaging) if desired. Once the data is packaged, it is sent to the destination at the specified interval at 810. The destination can utilize the feed data to perform customized reports, etc.

As used herein, the terms “component,” “system” and the like are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The word “exemplary” is used herein to mean serving as an example, instance or illustration. Any aspect or design described herein as “exemplary” is not necessarily to be construed as preferred or advantageous over other aspects or designs. Furthermore, examples are provided solely for purposes of clarity and understanding and are not meant to limit the subject innovation or relevant portion thereof in any manner. It is to be appreciated that a myriad of additional or alternate examples could have been presented, but have been omitted for purposes of brevity.

Furthermore, all or portions of the subject innovation may be implemented as a method, apparatus or article of manufacture using standard programming and/or engineering techniques to produce software, firmware, hardware, or any combination thereof to control a computer to implement the disclosed innovation. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

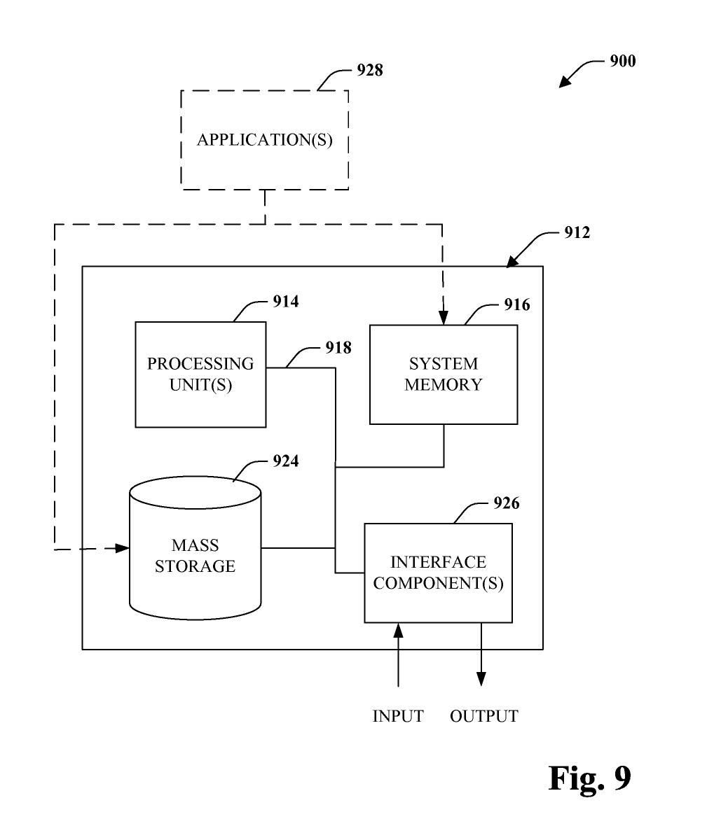

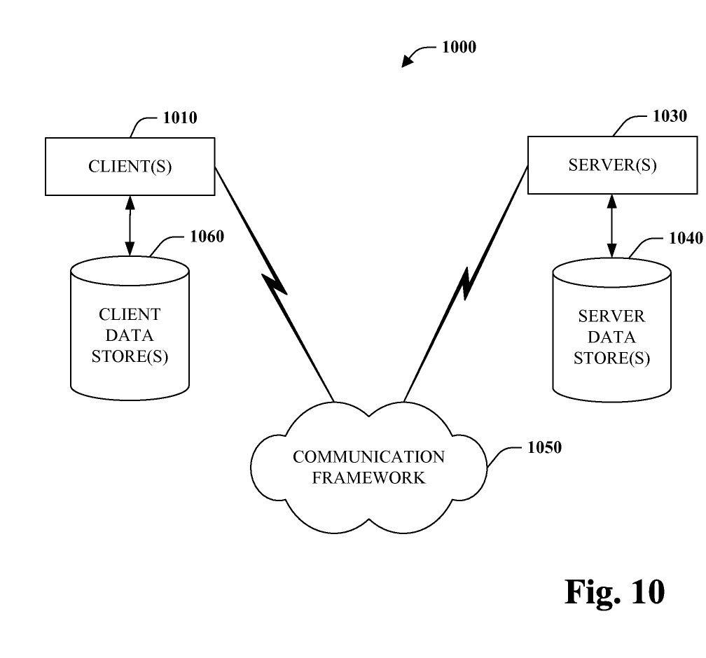

In order to provide a context for the various aspects of the disclosed subject matter, FIGS. 9 and 10 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the systems/methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed subject matter can be practiced on stand-alone computers. In a distributed computing environment, program modules may be located in both local and remote memory storage devices.

With reference to FIG. 9, an exemplary environment 900 for implementing various aspects disclosed herein includes a computer 912 (e.g., desktop, laptop, server, hand held, programmable consumer or industrial electronics . . . ). The computer 912 includes a processing unit 914, a system memory 916 and a system bus 918. The system bus 918 couples system components including, but not limited to, the system memory 916 to the processing unit 914. The processing unit 914 can be any of various available microprocessors. It is to be appreciated that dual microprocessors, multi-core and other multiprocessor architectures can be employed as the processing unit 914.

The system memory 916 includes volatile and nonvolatile memory. The basic input/output system (BIOS), containing the basic routines to transfer information between elements within the computer 912, such as during start-up, is stored in nonvolatile memory. By way of illustration, and not limitation, nonvolatile memory can include read only memory (ROM). Volatile memory includes random access memory (RAM), which can act as external cache memory to facilitate processing.

Computer 912 also includes removable/non-removable, volatile/non-volatile computer storage media. FIG. 9 illustrates, for example, mass storage 924. Mass storage 924 includes, but is not limited to, devices like a magnetic or optical disk drive, floppy disk drive, flash memory or memory stick. In addition, mass storage 924 can include storage media separately or in combination with other storage media.

FIG. 9 provides software application(s) 928 that act as an intermediary between users and/or other computers and the basic computer resources described in suitable operating environment 900. Such software application(s) 928 include one or both of system and application software. System software can include an operating system, which can be stored on mass storage 924, that acts to control and allocate resources of the computer system 912. Application software takes advantage of the management of resources by system software through program modules and data stored on either or both of system memory 916 and mass storage 924.

The computer 912 also includes one or more interface components 926 that are communicatively coupled to the bus 918 and facilitate interaction with the computer 912. By way of example, the interface component 926 can be a port (e.g., serial, parallel, PCMCIA, USB, FireWire . . . ) or an interface card (e.g., sound, video, network . . . ) or the like. The interface component 926 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer and the like. Output can also be supplied by the computer 912 to output device(s) via interface component 926. Output devices can include displays (e.g., CRT, LCD, plasma . . . ), speakers, printers and other computers, among other things.

FIG. 10 is a schematic block diagram of a sample-computing environment 1000 with which the subject innovation can interact. The system 1000 includes one or more client(s) 1010. The client(s) 1010 can be hardware and/or software (e.g., threads, processes, computing devices). The system 1000 also includes one or more server(s) 1030. Thus, system 1000 can correspond to a two-tier client server model or a multi-tier model (e.g., client, middle tier server, data server), amongst other models. The server(s) 1030 can also be hardware and/or software (e.g., threads, processes, computing devices). The servers 1030 can house threads to perform transformations by employing the aspects of the subject innovation, for example. One possible communication between a client 1010 and a server 1030 may be in the form of a data packet transmitted between two or more computer processes.

The system 1000 includes a communication framework 1050 that can be employed to facilitate communications between the client(s) 1010 and the server(s) 1030. Here, the client(s) 1010 can correspond to program application components and the server(s) 1030 can provide the functionality of the interface and optionally the storage system, as previously described. The client(s) 1010 are operatively connected to one or more client data store(s) 1060 that can be employed to store information local to the client(s) 1010. Similarly, the server(s) 1030 are operatively connected to one or more server data store(s) 1040 that can be employed to store information local to the servers 1030.

By way of example, a feed requesting client in accordance with the subject matter as described herein can be executed on or as a client 1010. The feed requesting client can request and/or create access to one or more data feeds for data available within a service platform, which can operate in conjunction with one or more servers 1030 over the communication framework 1050. The server(s) 1030 can operate in a service-based platform, for example, and one or more data stores 1040 can store data related to the service such as transaction information for a plurality of clients 1010. When the feed is requested by the client 1010, one or more of the servers 1030 can setup the feed and transmit it to the client 1010 based on interval or events, for example; the feed accesses data from one or more of the data stores 1040.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has” or “having” or variations in form thereof are used in either the detailed description or the claims, such terms are intended to be inclusive in a manner similar to the term “comprising” as “comprising” is interpreted when employed as a transitional word in a claim.

What is claimed is:

1. A system for distributing large data feeds to requesting clients, comprising:
a data warehouse that stores a plurality of usage tracking records relating to a client in a service platform, the usage tracking records comprising a plurality of data fields;
a feed manager that receives a request for subscription to at least a portion of the data fields, the request specifying at least one customized property; and
a feed replication component that packages the data fields of the usage tracking records in the data warehouse within a data feed and transmits the data feed to the client according to the customized property.

2. The system of claim 1, the customized property is a format specification for the data feed.

3. The system of claim 2, the format specification is SQL log shipping, the data feed is packaged according to the format before transmittal.

4. The system of claim 1, the feed manager comprises an interface component that facilitates specification of the request for subscription.

5. The system of claim 1, the feed manager comprises a policy component that ensures compliance of the data feed with at least one policy.

6. The system of claim 5, the policy relates to a maximum number of outstanding feeds with respect to the feed manager.

7. The system of claim 5, the policy relates to authorization of the request for subscription with respect to at least one of the data fields.

8. The system of claim 1, further comprising a feed database that stores data regarding the request for subscription, the feed replication component leverages the feed database packaging the data fields and transmitting the data feeds.

9. The system of claim 1, the feed manager tracks statistical data related to the data feed and allows access to the statistical data.

10. A method for distributing service-platform data feeds to a client, comprising:
receiving a request for at least one data feed;
storing data related to the request in a feed database; and
replicating feeds based at least in part on data stored in the feed database.

11. The method of claim 10, the replicated feeds are transmitted to a client to which the request for the data feed relates.

12. The method of claim 10, further comprising authenticating the request for the data feed utilizing a platform server from which data in the data feed originates.

13. The method of claim 10, the request for the data feed comprises identification of a requested format for the data feed and a requested interval for transmittal of the data feed.

14. The method of claim 13, the requested format is SQL log shipping.

15. The method of claim 10, the request for the data feed is customizable by identification of at least one data field requested as part of the data feed.

16. The method of claim 10, further comprising ensuring conformity of the request for the data feed with at least one policy upon receiving the request.

17. The method of claim 16, the policy relates to at least one integrity ensuring resource restriction.

18. The method of claim 17, the integrity ensuring resource restriction is a maximum number of outstanding feeds allowed.

19. A system for distributing data feeds to a plurality of clients, comprising:
means for receiving a request for subscription to at least a portion of a plurality of data fields associated with usage data in a service platform; and
means for packaging the requested data fields of the usage data within a data feed.

20. The system of claim 19, further comprising means for transmitting the data feed to a client architecture.
